(19) United States
(12) Patent Application Publication
(10) Pub. No.: US 2018/0050553 A1
(43) Pub. Date: Feb. 22, 2018

(54) BILL RECEIPT ADAPTABLE TO HOLD CURRENCY

(71) Applicant: Teresa Pritchett, Indianapolis, IN (US)

(72) Inventor: Teresa Pritchett, Indianapolis, IN (US)

(21) Appl. No.: 15/243,959

(22) Filed: Aug. 22, 2016

(51) Int. Cl. B42D 15/00; B65D 27/00; B65B 5/02; B65B 5/04

(52) U.S. Cl. CPC B42D 15/008; B65D 27/00; B42D 15/0053; B65B 5/04; B65B 5/02

(57) ABSTRACT

Disclosed here is a system and method of use of a bill receipt adaptable to hold currency while currency is being handed from a cashier to a customer. The bill receipt comprises a sheet of paper which is substantially symmetrically folded, and the edges adjacent to the folded edge are fastened, and the edge opposing the folded edge is not fastened to define an opening. A cash transaction is printed on an outer surface of the folded sheet of paper. A pocket is accessed through the opening, through which a cashier is allowed to insert currency into the pocket during a cash transaction between the cashier and the customer.

### FIELD OF THE INVENTION

The present invention relates to bill receipt adaptable to hold currency during transaction, and in particular, to manage currency transfer at POS, restaurants and other places where cashier issues bill.

### BACKGROUND OF THE INVENTION

Various systems and methods are existing to give back change or denominations after paying bills, and they are well known in commerce and industry sector. Over billions of cash transactions for less than $5 denomination occur per year around the world. Nearly all of these involve the currency that a cashier struggles to pull out of a drawer, or that a change dispenser dispenses. The customer, in general, loses the change multiple times, or generally doesn't care about the transaction. The businesses where cash is given in return as change, are hassled with the problem of the cashiers being subjected to continuously restock numerous pennies, nickels, dimes and quarters in order to enable smooth transactions and to avoid cash loss.

Each person in the United States uses about 749 pounds of paper every year. Almost 4 billion trees are cut down each year for paper use. The world uses 400 percent more paper now than 40 years before, and paper usage is everywhere. People use a whole sheet of paper just to note down a shopping list, and to print a small paragraph. Notices are printed on only one side of a sheet, and the other blank side of the notice is empty and unused.

Existing envelopes or notices are having advertising on the surfaces for promoting the facilities of the business entity, or bank from which the envelope or notice is issued. As a practical matter, new print cannot be made on the same envelope or notice, and the printing of advertising information on the surface of an envelope increases the cost of the envelope. It is common for people to waste advertisement papers or printed envelopes without reusing.

As mentioned above, there is no method or device which overcomes the limitations and drawbacks with respect to return of currency after paying bills. Therefore, there is an need of a device or a method with which a user can return the balace currency safely in an enclosed manner within an envelope. Further, the paper should be utilized optimaly in printing receipts and to make use of both the sides of a paper. It is therefore a principal object and advantage of the present invention to provide a method and system for providing change of currency in a pocket of a receipt made from the paper material.

### SUMMARY OF THE INVENTION

The present invention provides a system and method for providing bill receipt for holding the currency change. The bill receipt comprising a sheet of paper which is folded substantially symmetrical, the edges adjacent to the folded edge are fastened by any means of attachment. An opening is created between the edge opposing the folded edge which is not fastened and fastened folded edge. A cash transaction is printed on an outer surface of the folded sheet of paper. In a preferred embodiment, the pocket is accessed through the opening by a cashier by inserting currency into the pocket during the cash transaction between the cashier and a customer.

A method of holding currency in a bill receipt is also disclosed herein. The method comprising: folding a sheet of paper which is substantially symmetrical, fastening the edges adjacent to the folded edge, defining an opening by not fastening an edge opposing the folded edge, printing a cash transaction on an outer surface of the folded sheet of paper, defining a pocket between the folded sheet of paper, accessing the pocket through the opening, and inserting the currency into the pocket during the cash transaction between a cashier and a customer.

In a preferred embodiment, the bill receipt has shape characteristics and the cash transaction is related to the business identity to which the customer pays the bills. Also the bill paid by the customer reduces the wastage of paper and increases the paper utilization in a better way.

### BRIEF DESCRIPTION OF DRAWINGS

FIG. 1A shows a front elevation view of the bill receipt according to an embodiment of the present invention.

FIG. 1B shows a front perspective view of the bill receipt according to an embodiment of the present invention.

FIG. 2 shows a top perspective view of the bill receipt according to an embodiment of the present invention.

FIG. 3 shows the top perspective view of the bill receipt, with change kept inside the envelope, according to an embodiment of the present invention.

### DETAILED DESCRIPTION OF THE INVENTION

The following detailed description of the different exemplary embodiments presents a description of certain specific embodiments to assist in understanding the claims. However, the present invention is intended to cover alternatives, modifications and equivalents, which may be included within the spirit and scope of the invention as defined by the appended claims.

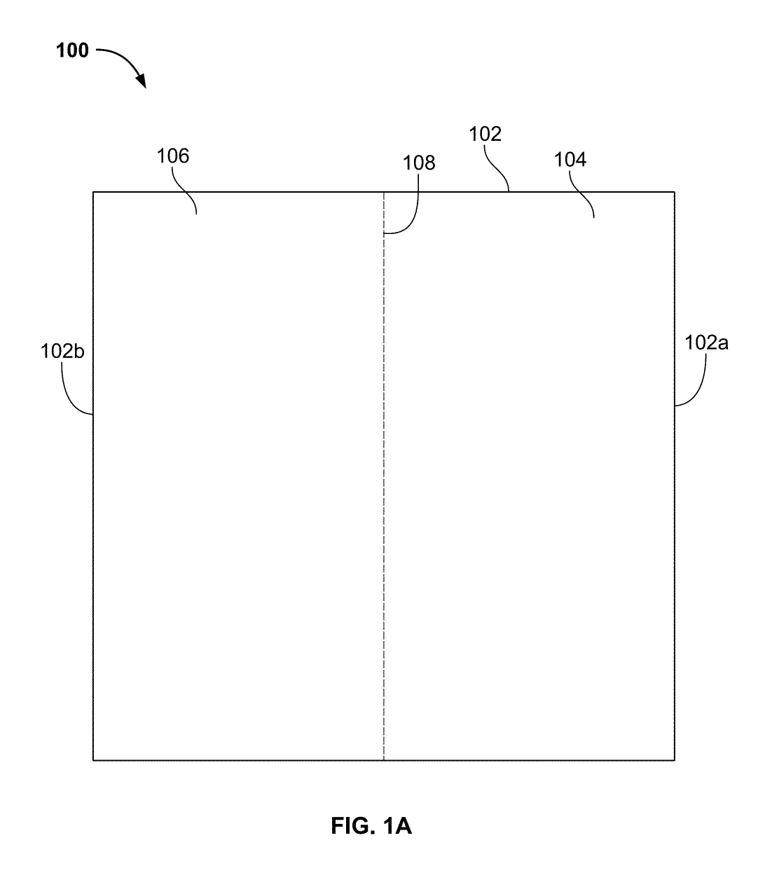

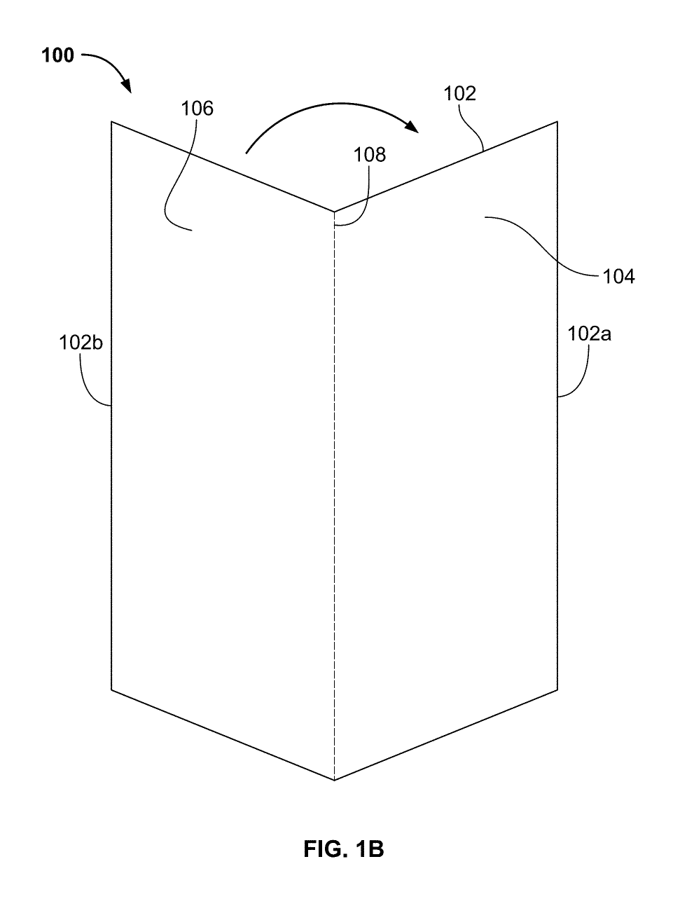

According to FIG. 1A which shows a front elevation view of a bill receipt 100 according to an embodiment of the present invention. A double wide receipt having a sheet of paper 102 comprises edges 102a and 102b as shown in FIG. 1A. The sheet of paper 102 comprises a first folded side 106 and second folded side 104 for printing cash transaction details. Referring to the FIG. 1A as illustrated, it shall be understood that the bill receipt 100 is formed from any suitable material, such as paper, capable of being imprinted with receipt, advertising and logo, image or indicia on all surfaces through the use of modern high speed web offset, or other production equipments known in the art.

According to FIG. 1A and FIG. 1B which shows a front perspective view of the bill receipt 100 according to an embodiment of the present invention. The section or the folded edge 108 is positioned substantialy perpendicular across the long horizontal axis of the first folded side 106 as seen in FIG. 1B. The additional embodiments of FIG. 1B illustrate the bill receipt 100 having the first folded side 106 showing in its open position. Although, it should be noted that the open position shall vary in shapes and sizes, thereby accordingly the additional space is required and a structural basis is necessary in order to print the transaction details. Conversely, the closed position of shall not exceed the size proximity of the bill receipt 100.

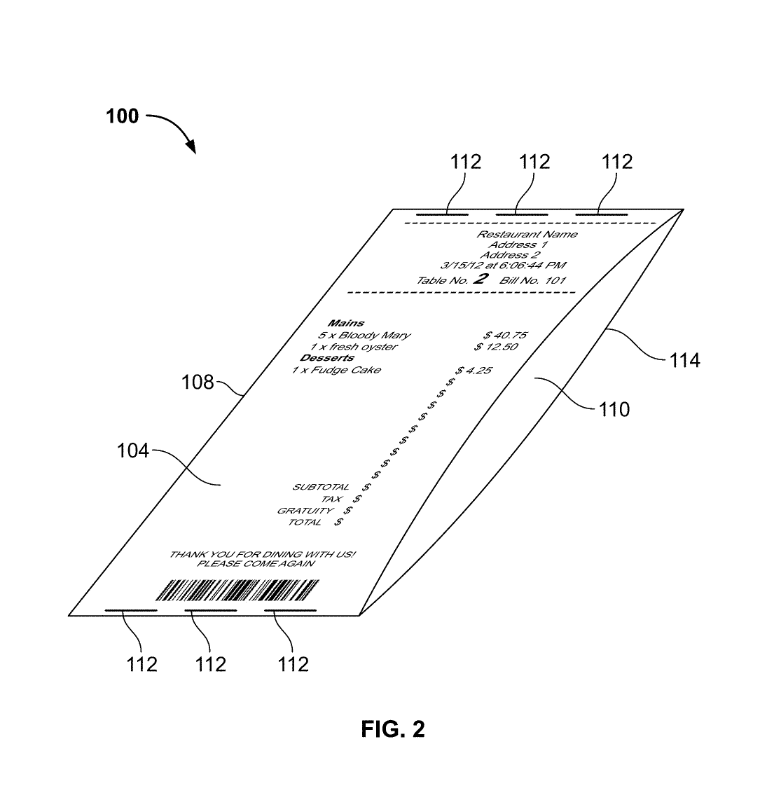

According to FIG. 2 which shows a top perspective view of the bill receipt 100 according to an embodiment of the present invention. FIG. 2 demonstrates a configuration of a bill receipt 100 including the folded edge 108 in relation to their adjacent edges underlying cash transaction details printed on the second folded side 104. Likewise, FIG. 2 illustrates a different alternate configuration for bill receipt 100 wherein the edges 102a and 102b opposing the folded edge 108 is not fastened to define an opening 114. The sides adjacent to this section are fastened using stapler 112 or glue or any means of attachment. Additionally, the preferred embodiment of FIG. 2 illustrates the adjacent edges that are fastened, or attached with a non-releasable adhesive. In some cases, if all the corners of the bill receipt are not attached to each other, the folded edge 108 can be fastened and thereby the cashier is able to print desired matter on the second folded side 104 during the transaction between the cashier and the customer. The bill receipt 100 can also comprises two sheets of paper glued to each other.

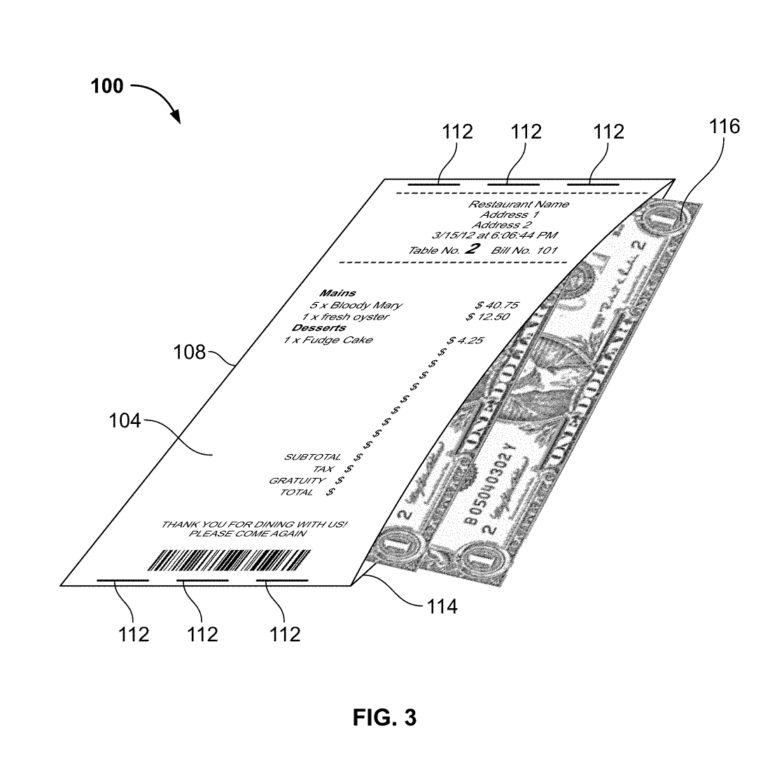

As shown in FIG. 3 which shows the bill receipt 100, with the currency 116 kept inside the bill receipt 100, according to an embodiment of the present invention. The bill receipt 100 for holding currency 116 is made by folding a substantially symmetrical sheet of paper 102. The edges 102a and 102b adjacent to the folded edge 108 of the paper 102 are fastened by stapler 112, glue, or fastened by any means of attachment. The opening 114 is created by not fastening the edge opposing to the folded edge 108. The cash transaction details are printed on an outer surface, for example, the second folded side 104 of the folded sheet of paper 102. A pocket 110 is defined between the folded sheet of paper 102. The pocket 110 is accessed through the opening 114 by a cashier and allowed to insert currency 116 into the pocket 110 during the cash transaction details between the cashier and the customer.

In the preferred embodiment,the cashier places bill receipt 100 owed to the customer. The currency 116 is, for example, cash, coins, paper money, bank notes, dollar, money or dinar or rupee. The cash transaction is printed on one or both surfaces of the folded sheet of paper 102. The bill receipt 100 secures the currency 116 in the opening 114 so that it does not slip or fall easily during transfer, but the bill receipt 100 also provides cash transaction details printed on the bill receipt 100 to the customer. In the preferred embodiment, the bill receipt 100 is one of a shape rectangular and a square shape. The bill receipt 100 has shape characteristics, image characteristics and details that all relate to the identity of a business entity. The bill receipt 100 comprises an image printed on the surface of the folded sheet of paper 102. The bill receipt 100 can be printed in bulk roll of paper attached to each other.

Further referring to FIGS. 2-3, a method of holding currency 116 in a bill receipt 100 is also disclosed herein. The method comprising: folding a sheet of paper 102 which is substantially symmetrical, fastening the edges 102a and 102b adjacent to the folded edge 108, defining an opening 114 by not fastening an edge opposing the folded edge 108, printing a cash transaction on an outer surface of the folded sheet of paper 102, defining a pocket 110 between the folded sheet of paper 102, accessing the pocket 110 through the opening 114, and inserting the currency 116 into the pocket 110 during the cash transaction between a cashier and a customer.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

I claim:

1. A bill receipt adaptable to hold currency, the bill receipt comprising;
a sheet of paper folded substantially symmetrical, wherein the edges adjacent to the folded edge are fastened, and the edge opposing the folded edge is not fastened to define an opening therebetween, wherein a cash transaction is printed on an outer surface of the folded sheet of paper; and
a pocket defined between the folded sheet of paper, wherein the pocket is accessed through the opening, wherein a cashier is allowed to insert currency into the pocket during the cash transaction between the cashier and a customer.

2. The bill receipt of claim 1, wherein the bill receipt is one of a shape rectangular and a square shape.

3. The bill receipt of claim 1, wherein the bill receipt comprises an image printed on the surface of the folded sheet of paper.

4. The bill receipt of claim 1, wherein the cash transaction is printed on one or both surfaces of the folded sheet of paper.

5. The bill receipt of claim 1, wherein the bill receipt comprises two sheets of paper glued to each other.

6. The bill receipt of claim 1, wherein the sheet of paper is in the form of a roll.

7. A method of holding currency in a bill receipt, the method comprising;
folding a sheet of paper which is substantially symmetrical;
fastening the edges adjacent to the folded edge;
defining an opening by not fastening an edge opposing the folded edge;
printing a cash transaction on an outer surface of the folded sheet of paper;
defining a pocket between the folded sheet of paper;
accessing the pocket through the opening; and
inserting the currency into the pocket during the cash transaction between a cashier and a customer.

8. The method of claim 7, wherein the bill receipt is one of a shape rectangular and a square shape.

9. The method of claim 7, wherein the bill receipt comprises an image printed on the surface of the folded sheet of paper.

10. The method of claim 7, wherein the cash transaction is printed on one or both surfaces of the folded sheet of paper.

11. The method of claim 7, wherein the bill receipt comprises two sheets of paper glued to each other.

12. The method of claim 7, wherein the sheet of paper is in the form of a roll.
